(19) United States
(12) Patent Application Publication
(10) Pub. No.: US 2025/0052572 A1
(43) Pub. Date: Feb. 13, 2025

(54) SUBSEA MEASUREMENT APPARATUS, METHOD OF COMPRESSSING MEASUREMENT DATA AND METHOD OF PROVIDING INTER-COMPATIBILITY BETWEEN APPARATUS

(71) Applicant: Sonardyne International Limited, Hampshire (GB)

(72) Inventors: Thomas CULVERHOUSE, Gloucestershire (GB); Darryl NEWBOROUGH, Hampshire (GB)

(73) Assignee: Sonardyne International Limited, Hampshire (GB)

(21) Appl. No.: 18/719,109

(22) PCT Filed: Dec. 13, 2023
(86) PCT No.: PCT/EP2022/085521

§ 371 Date: Jun. 12, 2024

(30) Foreign Application Priority Data
Dec. 13, 2021 (GB) 2118026.0

(51) Int. Cl. G01C 13/00; G06F 9/50; H04B 11/00; H04B 13/02

(52) U.S. Cl. CPC G01C 13/00; G06F 9/5027; H04B 13/02; H04B 11/00

(57) ABSTRACT

A subsea measurement apparatus (104) is configured to be immersed, when in use, in water, and comprises a sensor, a communications module, and a processing resource operably coupled to the sensor and the communications module. The sensor is configured to measure a property of a medium and the processing resource is configured to provide a first execution environment (122) and a second execution environment (124) independent from the first execution environment (122). The first execution environment (122) is configured to execute device firmware (128) that cooperates with the sensor to generate, when in use, measurement data. The second execution environment (124) is configured to receive and execute a user-defined application (130).

The present invention relates to an underwater measurement apparatus of the type that, for example, is deployed in a body of water for making measurements in respect of an aquatic environment in which the apparatus is deployed. The present invention also relates to a method of compressing data, the method being of the type that, for example, comprises an underwater measurement apparatus making measurements in respect of an aquatic environment in which the underwater measurement apparatus is deployed. The present invention further relates to a method of providing inter-compatibility between apparatus, the method being of the type that, for example, comprises an underwater measurement apparatus communicating with another apparatus where the underwater measurement apparatus and the another apparatus support different command protocols.

It is known to deploy subsea devices without the use of subsea cabling, the subsea devices being independent and supported by internal batteries for power, for example subsea nodes and other measurement apparatus. Communications with a given subsea device are therefore limited to short-range, high-bandwidth optical methods, for example employing a BlueComm™ underwater optical modem available from Sonardyne International Limited, UK, or long-range, low-bandwidth methods, for example employing the Compatt™ acoustic modern and its derivatives, also available from Sonardyne International Limited, UK.

Of these two communications techniques, acoustic methods typically consume less power and support greater communications ranges than optical communications methods, and so are often favoured. Existing acoustic modems are often used to transmit and receive small packets of data for the purpose of time-synchronisation or accurate positioning of subsea devices. Although the payload size of such packets of data is limited as a result of the low bandwidth of the acoustic modem, some limited communication with the subsea device is possible. However, the acoustic communications channel used by the subsea device is unsuitable for transport of a variety of data, including raw data packets, command and control messages, and files. While large data or files could conceivably be transmitted acoustically, the time taken for communication of such information would be prohibitively long: the communications time being impractical and a heavy consumption demand would be placed on the batteries of the subsea device, thereby reducing the in-situ service life of the subsea device. In addition, communications to a vessel of such duration would be economically inefficient due to vessel hire costs.

Additionally, subsea devices are often designed to measure and generate raw, or ‘slightly’ processed, data for analysis post-deployment. While every effort is made to ensure that the subsea device meets customer requirements in terms of the measurement of physical quantities of interest, it is not viable commercially to satisfy the needs of all customers, environments, and use-cases. Subsea devices are therefore inherently limited to some degree in terms of the scope of their operation and the data that the subsea devices can gather. For example, a so-called Acoustic Doppler Current Profiler (ADCP) primarily measures currents through a water column. However, the data the ADCP captures can also be used, for example, to track diel migration of zooplankton, monitor boundary layers in fjords, measure wave height and direction to name but a few applications. For such myriad applications, it is not feasible to develop and maintain firmware for the subsea device, such as the ADCP, that can measure such a variety of properties locally on the subsea device. Indeed, attempting to accommodate so many applications may also result in so-called “feature bloat”, whereby users of the subsea device become overwhelmed with the number of available options as compared with their desired application. An additional processing demand is also placed on the processing resources of the subsea device, as well as the battery, storage capacity and processing time of the subsea device.

According to a first aspect of the present invention, there is provided a subsea measurement apparatus configured to be immersed, when in use, in water, the apparatus comprising: a sensor; a communications module; a processing resource operably coupled to the sensor and the communications module, the sensor being configured to measure a property of a medium; wherein the processing resource is configured to provide a first execution environment and a second execution environment independent from the first execution environment; the first execution environment is configured to execute device firmware that cooperates with the sensor to generate, when in use, measurement data; and the second execution environment is configured to receive and execute a user-defined application.

The sensor may be an inertial sensor or an environmental sensor. The sensor may be an acoustic sensor or an optical sensor.

The first execution environment may be functionally partitioned from the second execution environment.

The apparatus may comprise a housing configured to withstand deposition on a seabed. The housing may be a pressure vessel.

The user-defined application of the second execution environment may be configured to acquire the measurement data having a first information value and to process the measurement data to produce processed output data having a second information value.

A size of the processed output data may be smaller than a size of the measurement data.

The second information value may be greater than the first information value.

The subsea measurement apparatus may be a remote subsea measurement apparatus. The subsea measurement apparatus may be untethered, for example not cabled to a topside computing apparatus. The subsea measurement apparatus may be deployed, when in use, underwater. The subsea measurement apparatus may not employ a physical connection when communicating the processed output data. The communications module may be a wireless communications module. The subsea measurement apparatus may comprise a wired communications interface.

The user-defined application may be a command interpreter configured to receive a first command in accordance with a first command protocol and to translate the first command to a second command in accordance with a second command protocol.

The user-defined application may be configured to generate a command to control operation of the first execution environment and to communicate the command to the first execution environment in order to modify operational behaviour of the first execution environment.

The command may be generated in response to an assessment of a predetermined criterion. The user-defined application may obtain measurement data generated by the first execution environment and analyse the measurement data with respect to the predetermined criterion.

The user-defined application may be configured to perform, when in use, a predetermined functionality; the user-defined application may be further configured to receive a command associated with the predetermined functionality and the user-defined application may be configured to modify the predetermined functionality in response to and in accordance with the received command.

The predetermined functionality may be processing of data generated by the first execution environment; the processing of the data may have a processing parameter associated therewith. The command is configured to modify the processing parameter; and the user-defined application may be further configured to modify the processing of the data in response to and in accordance with the received command.

The apparatus may further comprise: an acoustic communications transceiver operably coupled to the communications module.

The second execution environment may be configured to permit replacement of the user-defined application with another user-defined application.

The second execution environment may be configured to support another user-defined application. The another user-defined application may be configured to cooperate with the user-defined application.

The user-defined application may be configured to process, when in use, the measurement data in order to implement a first measurement application.

The another user-defined applicant may be configured to process, when in use, the measurement data in order to implement a second measurement application.

The second execution environment may be a runtime environment.

The communication module may comprise an acoustic modem.

The second execution environment may be configured to execute the user-defined application in accordance with a predetermined execution frequency.

The apparatus may further comprise: a command interface for receiving an operational command; wherein the second execution environment may be configured to provide access to the command interface.

The second execution environment may be configured to receive the user-defined application via a communications link and to execute the user-defined application in the second execution environment.

The communications link may be supported by the communications module.

The apparatus may comprise a pressure vessel; the pressure vessel may comprise the communications module and the processing resource.

The apparatus may comprise a first pressure vessel and a second pressure vessel; the first pressure vessel may comprise the communications module and the second pressure vessel may comprise the processing resource.

The apparatus may comprise another sensor module configured to measure another property of the medium or another medium; the another sensor module may be configured to communicate with the processing resource. The user-defined application may be configured to receive further measurement data from the another sensor module. The user-defined application may process the further measurement data. The user-defined application may be configured to combine the processed further measurement data with the processed output data or the measurement data.

The another sensor may be external to the apparatus. The combination of the processed further measurement data with the processed output data may be fusion of the processed further measurement data with the processed output data with respect to time.

According to a second aspect of the present invention, there is provided a subsea measurement system comprising: the subsea measurement apparatus as set forth above in relation to the first aspect of the present invention; and a topside module configured to communicate with the subsea measurement apparatus.

The system may further comprise: a computing device independent of the topside module and configured to communicate with the topside module; wherein the topside module may be configured to receive an application package from the computing device.

The topside device may be configured to communicate the application package to the subsea measurement apparatus.

The application package may comprise a runtime library and processing code configured to use the runtime library.

The computing device may comprise, when in use, a software development kit configured to support creation of an application for execution in the second execution environment of the subsea measurement apparatus.

The first execution environment may be configured to support a control application; the control application is configured to control execution of the user-defined application. The control of the user-defined application by the control application may be in response to an operational status of the first execution environment. The operational status of the first execution environment may be a data generation status. The data generation status may be an availability of a data file or a data packet.

The medium may be an underwater environment.

According to a third aspect of the present invention, there is provided a method of compressing measurement data, the method comprising: providing a processing resource to support a first execution environment and a second execution environment; executing firmware in the first execution environment; obtaining a sensor measurement in respect of a medium; pre-processing the sensor measurement using the firmware to produce measurement data having first information value; executing a user-defined application in the second execution environment to obtain the measurement data and processing the measurement data in accordance with a predetermined processing algorithm, thereby producing processed measurement data having second information value.

A size of the processed measurement data may be smaller than a size of the measurement data.

The processed measurement data may be transmitted acoustically through the aquatic underwater environment.

According to a fourth aspect of the present invention, there is provided a method of providing inter-compatibility with an underwater measurement apparatus, the method comprising: providing a processing resource in the underwater measurement apparatus to support a first execution environment and a second execution environment; executing firmware in the first execution environment; obtaining a sensor measurement in respect of a medium; pre-processing the sensor measurement using the firmware to produce measurement data having first information value; executing a user-defined application in the second execution environment to provide a command interpreter configured to receive a first command in accordance with a first command protocol and to translate the first command to a second command in accordance with a second command protocol, the firmware being configured to operate in accordance with the second command protocol.

A communications module may be configured to receive the first command. The communications module may be configured to support a communications channel. The communications channel may be an acoustic communications channel. The communications channel may be an optical communications channel.

It is thus possible to provide an apparatus and method that enable useful processing results from raw or partially processed data to be obtained without the need to recover the underwater measurement apparatus. Furthermore, such processing results can be obtained with the additional benefit of flexibility in supporting user-defined analysis of the raw or partially processed local data. The apparatus also supports improved interoperability between hardware of different manufacturers, for example a topside module of one manufacturer can be used with an underwater measurement apparatus of another manufacturer. Improved control of the underwater measurement apparatus is also possible by way of, for example, local control of an operational parameter of the underwater measurement apparatus. In this regard, it is possible to apply onboard decision-making, for example through employing artificial intelligence/machine learning techniques in the absence of human intervention. The method and apparatus support the ability to modify the user-defined application while the underwater measurement apparatus is in the field and in use. The method and apparatus also enable measurement data and quality and/or performance metrics to be fused for auditing purposes. The method and apparatus also support the fusing of the measurement data with measurement data from one of more peripheral sensor.

At least one embodiment of the invention will now be described, by way of example only, with reference to the accompanying drawings, in which:

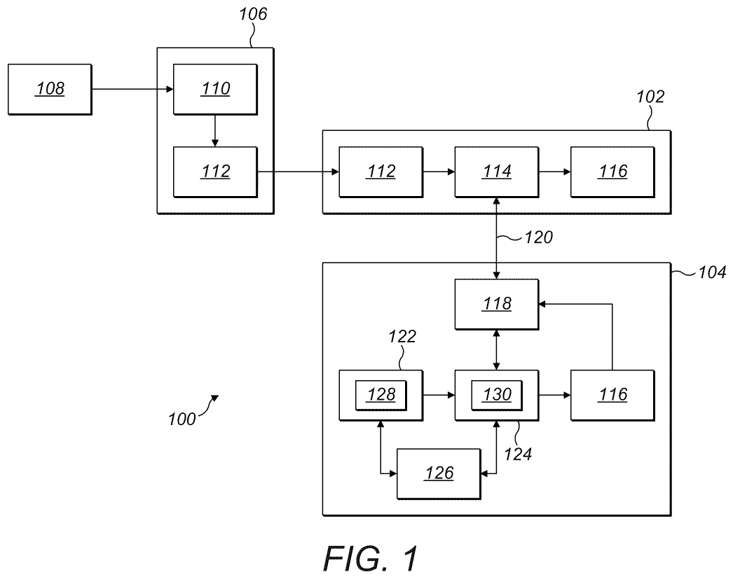

FIG. 1 is a schematic diagram of an underwater measurement system constituting an embodiment of the invention;

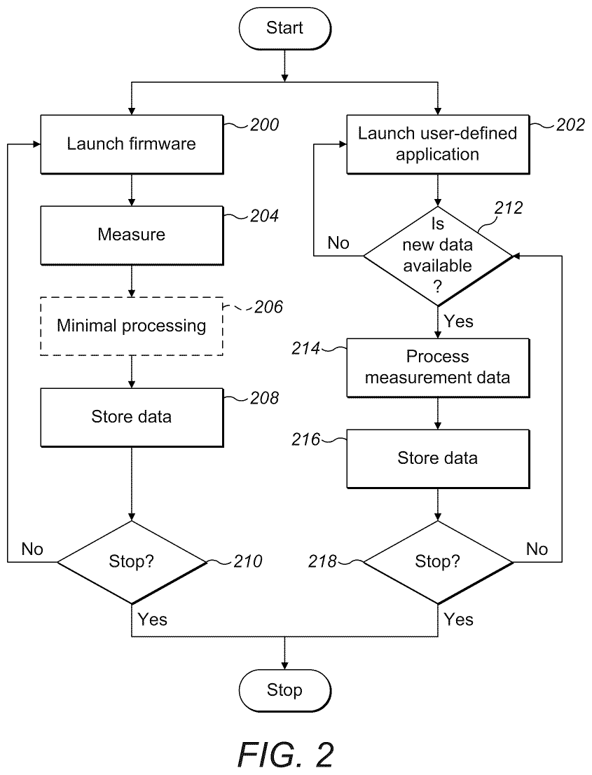

FIG. 2 is a flow diagram of a method of compressing measurement data constituting another embodiment of the invention; and

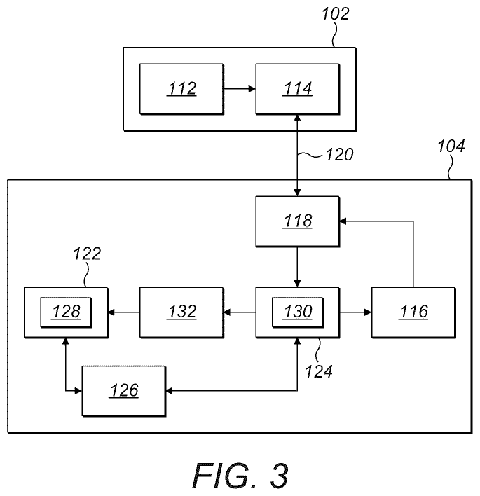

FIG. 3 is a schematic diagram of the system of FIG. 1 configured to provide command protocol translation and constituting a further embodiment of the invention:

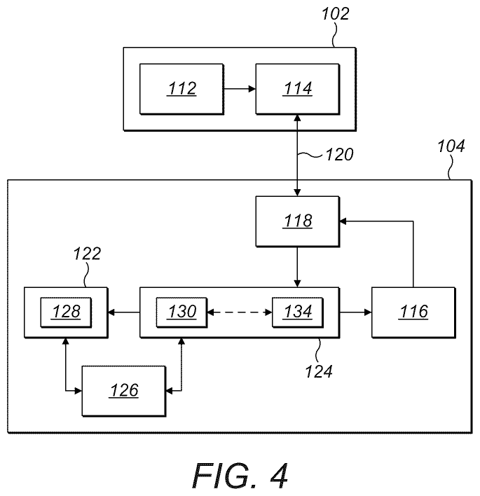

FIG. 4 is a schematic diagram of the system of FIG. 1 configured to support multiple user-defined applications and constituting yet another embodiment of the invention; and

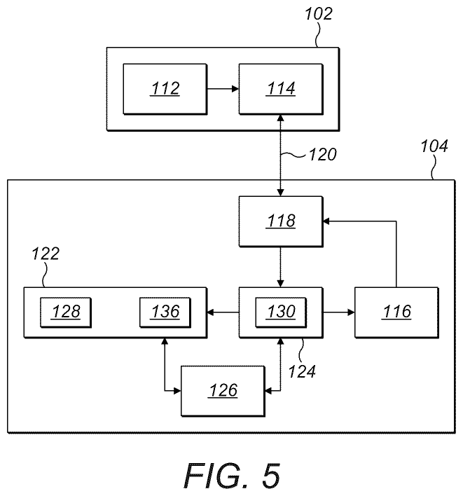

FIG. 5 is a schematic diagram of the system of FIG. 1 configured to control triggering of a user-defined application and constituting a further embodiment of the invention.

Throughout the following description identical reference numerals will be used to identify like parts.

Referring to FIG. 1, an underwater measurement system 100 comprises a topside computing apparatus (module) 102 capable of communicating with an underwater apparatus, for example an underwater measurement apparatus 104, such as an Acoustic Doppler Current Profiler (ADCP). The underwater apparatus can be a subsea apparatus, depending upon application requirements. The underwater measurement apparatus comprises, in this example, a housing, which can be configured to withstand deposition underwater, such as on a seabed. In this regard, the housing can be a pressure vessel. It is assumed, in this example, that the underwater measurement apparatus 104 is deployed in an underwater aquatic environment. The underwater measurement apparatus 104 is a remote subsea measurement apparatus and so, in this example, is untethered, for example not cabled to the topside computing apparatus 102.

When required, the topside computing apparatus 102 is coupled, either directly or via a communications network, to a remote computing apparatus 106, for example a Personal Computer (PC). The topside computing apparatus 102 is similarly, in this example, a PC.

In this example, a Software Development Kit (SDK) installer 108 is saved to the remote computing apparatus 106 and executed to install an SDK application 110 onto the remote computing apparatus 106 for the development of a user-defined application. Upon completion of development of the user-defined application, the SDK application 110 outputs an application package 112, which includes a runtime library, and processing code (not shown) that uses the runtime library. The application package 112 is then transferred to the topside computing apparatus 102 for deployment on the underwater measurement apparatus 104. In some embodiments though, the skilled person will appreciate that the remote computing apparatus 106 does not need to be operably coupled to the topside computing apparatus 102 and the remote computing apparatus 106 can be coupled temporarily to the underwater measurement apparatus 104 for transferral of the application package 112 to the underwater measurement apparatus 104, for example via an Ethernet connection prior to deployment of the underwater measurement apparatus 104.

The topside computing apparatus 102 comprises a first acoustic modem 114 and a first data store, for example a hard drive or a non-volatile memory device, such as a Solid State Drive (SSD). The first data store comprises a dedicated partitioned region in which to record application data 116. The underwater measurement apparatus 104 comprises a communications module having a second acoustic modem 118 capable of communicating with the first acoustic modem 114. Together, the first and second acoustic modems 114, 118 support an acoustic communications channel 120. The second acoustic modem 118 is operably coupled to a processing resource (not shown) for example a processor, the processor supporting a first execution environment 122 and a second execution environment 124, the first execution environment 122 being capable of communicating with a second execution environment 124. The first execution environment 122 is, in this example, functionally partitioned from the second execution environment 124, and the second execution environment is a runtime environment. The underwater measurement apparatus 104 also comprises a second data store operably coupled to the processing resource, for example a hard drive or a non-volatile memory device, such as an SSD, in order to record the application data 116 locally and also record measurement data 126 natively collected by firmware 128 running in the first execution environment 122, the measurement data 126 being raw, for example unprocessed or minimally processed, for example arranged in the so-called PDO format. In this regard, the second data store can comprise dedicated partitioned regions to store the application data 116 and the measurement data 126, respectively. The processing resource is operably coupled to the communications module and a sensor (not shown). In this example, the sensor is an acoustic sensor, but the sensor can be any suitable underwater sensor, for example an inertial sensor or an environmental sensor, such as a pressure sensor or a temperature sensor. The technology supporting the sensor can be, for example acoustic or optical. In other examples, one or more additional sensor modules external to the underwater measurement apparatus 104 can be operably coupled to the underwater measurement apparatus 104. The one or more additional sensors can be configured to measure another property of the underwater environment and/or indeed another medium, for example temperature of the water column. The one or more additional sensor modules can be configured to communicate with the processing resource so that the user-defined application 130 can receive further measurement data, for example temperature measurement data, from the one or more additional sensors and process the further measurement data.

In this example, to deploy the user-defined application 130, the application package 112 is communicated from the topside computing apparatus 102 to the underwater measurement apparatus 104, through the aquatic environment in which the underwater measurement apparatus 104 is deployed, via the acoustic communications channel 120, whereupon once received, the application package 112 is unpacked and installed in the second execution environment 124 and executed. In this example, the user-defined application 130 is executed with a predetermined frequency to process the measurement data collected by the firmware 128.

It can therefore be seen that the user-defined application is downloadable onto the underwater measurement apparatus 104 and indeed can be replaced by another user-defined application communicated from the topside computing apparatus 102, when desired.

In operation, the firmware 128 of the underwater measurement apparatus 104 executes (Step 200) in the first execution environment 122 and the user-defined application 130 executes (Step 202) in the second execution environment 124. The firmware 130 performs a number of manufacturer-defined functions, including control of the measurement hardware (not shown) of the underwater measurement apparatus 104, for example the sensor, and receiving signals from the sensor and generating measurement data, which for the sake of simplicity and clarity shall be referred to as one or more acquisition processes. An acquisition process generates (Step 204) measurement data that is, optionally minimally processed (Step 206) and, stored (Step 208) in the second data store as the measurement data 126. In this example, minimally processed data can be processing to reject so-called “outlier” results, for example filtering out unphysical spikes, time averaging and/or spatial averaging.

The acquisition process or any other suitable process receives one or more sensor measurements and pre-processes the one or more sensor measurement, i.e. the firmware pre-processes the one or more sensor measurement, to produce measurement data that is stored. The measurement data has a first information value. In this respect, the value of the measurement data can be assessed in respect of one or more parameters relating to the data, ranging from a measure of the usefulness of the information content to the size of the data. This process is repeated (Steps 204 to 208) until acquisition by the underwater measurement apparatus is no longer required (Step 210).

The user-defined application 130 running in the second execution environment 124 is configured to execute a predetermined processing algorithm. In this example, the predetermined processing algorithm is designed to determine (Step 212) when new measurement data 126 is stored in the second data store and to process (Step 214) the new measurement data to yield processed measurement data that has a second information value different from the first information value. The processed measurement data 116 is then stored (Step 216) in the second data store as the application data 116. It should, however, be appreciated that in other examples the processed measurement data 116 need not be stored long-term and can be, for example, communicated to the topside computing apparatus 102 requiring only buffering as opposed to logging prior to communication. This process is repeated (Steps 212 to 216) until acquisition by the processing of the measurement data is no longer required (Step 218). In one example, the second information value differs from the first information value in its size, i.e. the processed measurement data is much smaller than the raw or partially-processed measurement data, and so, much more compatible with efficient communication over the acoustic communications channel 120 back to the topside computing apparatus 102. In one example, the user-defined application 130 is configured to process the measurement generated by the firmware 128 in order to track zooplankton migration. In another example, the user-defined application 130 is configured to process the measurement data generated by the firmware 128 in order to monitor boundary layers, for example in fjords. Another application for a user-defined application includes monitoring of wave motion, for example wave height and/or direction. These applications are purely examples and many others exist.

In examples where one or more additional sensor modules are coupled to the underwater measurement apparatus 104, the user-defined application 130 can combine the processed further measurement data with the raw or partially-processed measurement data during processing thereof by the user-defined application 126, or the processed measurement data. In this regard, the combination of the processed further measurement data with the measurement data, during processing thereof, or the processed measurement data can be fusion of the processed further measurement data with the measurement data or the processed measurement data with respect to time. Indeed, it should also be appreciated that the user-defined application 130 can, in some examples, process the processed measurement data further. In other examples, quality and/or performance metrics, for example battery performance vs. time or sensor performance vs. time metrics, can be fused with the measurement data during processing or the processed measurement data. In relation to measuring sensor performance, if for example biofouling or some other kind of external stimulus is affecting the sensor, it is sometimes possible to measure the effect of such a stimulus.

It should be appreciated that, although in the example set forth above in relation to FIG. 2, the user-defined application 130 is launched (Step 202) upon start up and then new data is processed as it is generated. other implementations are contemplated. Indeed, in another example, as will be described later herein, for example in relation to FIG. 5, the user-defined application 130 is not launched until new data becomes available, for example for a data file processing implementation.

As can be seen, the underwater measurement apparatus 104 does not, in the above examples, employ a physical connection when communicating the processed measurement data 116 to the topside computing apparatus 102. The communications module is, in this example, a wireless communications module, but as also described above, the underwater measurement apparatus 104 comprises a wired communications interface for communicating with the underwater measurement apparatus 104 when not deployed underwater.

In another embodiment, the user-defined application 130 is configured so that the operation thereof can be modified. In one example, a command can be issued from the topside computing apparatus 102 and communicated to the user-defined application 130 via the acoustic communications channel 120, the user-defined application 130 being configured to receive the command. In other examples, a user application can be executed, for example on the topside computing apparatus 102, that generates a configuration file that is communicated to the user-defined application 130 via the acoustic communications channel 120, the configuration file comprising data and instructions to modify the operation of the user-defined application 130.

The command, in this example, relates to a predetermined function performed by the user-defined application 130, for example a parameter relating to processing of the measurement data by the user-defined application 130. In this regard, the parameter can be, for example, a period in time over which collected measurement data is selected for processing. The command comprises an instruction to be executed by the user-defined application 130 to modify operation thereof as defined by the processing parameter, the processing parameter being included with the command in this example. Upon receipt of the command, the user-defined application 130 modifies the operation thereof in accordance with the processing parameter. The modification of the predetermined functionality of the user-defined application 130 is in response to receipt of the command.

In another example, the user-defined application 130 is configured to monitor operation of the firmware 128, for example an aspect of operation of the firmware 130, such as a function performed by the firmware 128, and to modify an operational behaviour of the firmware 128. In such an example, processing of the measurement processed data is not necessarily a function of the user-defined application 130. The user-defined application 130 generates a command in accordance with a first command protocol of the underwater measurement apparatus 104 and communicates the command to the firmware 128. In this example, the user-defined application 130 is configured to assess a predetermined criterion. For example, the user-defined application 130 can analyse measurement data 126 generated by the firmware 128 with respect to the predetermined criterion, such as a noise level associated with the measurement data 126. If the criterion is not satisfied, then the command is generated by the user-defined application 130 including a calculated or referenced parameter to modify the operational behaviour of the firmware 128, for example an averaging period or a measurement frequency.

At any time during operation of the underwater measurement apparatus 104, the user-defined application 130 can be replaced by another user-defined application installed in the same manner as the user-defined application 130. In this regard, the user-defined application 130 can be configured to process the measurement data 126 in order to implement a first measurement application, and the replacement, another, user-defined application can be configured to process the measurement data 126 in order to implement a second measurement application.

In another embodiment (FIG. 3), the first execution environment 122 supports a command interface 132, which is also the case in relation to the embodiments of FIG. 1, but just not illustrated for the sake of simplicity and clarity of description. The second execution environment 124 is configured to provide access to the command interface 132. Typically, the manufacturer of the underwater measurement apparatus 104 is the same as the manufacturer of the topside computing apparatus 102. However, in this embodiment, the manufacturer of the underwater measurement apparatus 104 is different to the manufacturer of the topside computing apparatus 102. Such a configuration can arise where, in an existing underwater measurement system having a manufacturer in common for both the underwater measurement apparatus and the topside computing apparatus 102, it is decided to replace the existing underwater measurement apparatus with the underwater measurement apparatus 104, for example an ADCP, that is manufactured by a different manufacturer to the topside computing apparatus 102. In such a configuration, the command interface 132 is typically incompatible with a first command protocol of the topside computing apparatus 102, because a second command protocol supported by the command interface 132 of the replacement underwater measurement apparatus 104 is specific to the manufacturer of the underwater measurement apparatus 104, in a like manner to the first command protocol being specific to the manufacturer of the topside computing apparatus 102. Another analogous example is where the topside computing apparatus 102 is configured to cooperate with an underwater inertial measurement apparatus made by the same manufacturer as the topside computing apparatus 102, but where the manufacturer of the actual underwater inertial apparatus to be deployed is different from the manufacturer of the topside computing apparatus 102. In this embodiment, the communications channel 120 can be an optical communications channel instead of, or in addition to, the acoustic communications channel.

In this example, the underwater measurement apparatus 104 is of the same type as described above in relation to FIG. 1 and the user-defined application 130 can also be installed on the underwater measurement apparatus 104 by a hardwired connection prior to deployment of the underwater measurement apparatus 104 if necessary. In this example, the user-defined application 130 is a command interface converter. The command interface interpreter 130 is configured to receive a first command from the topside computing apparatus 102 in accordance with the first command protocol employed by the topside computing apparatus 102 and to translate the first command to a second command in accordance with the second command protocol employed by the underwater measurement apparatus 104.

As mentioned above, the user-defined application 130 can be replaced by another user-defined application. However, in yet another embodiment (FIG. 4), the another user-defined application 134 is deployed on the underwater measurement apparatus 104 onto the second execution environment 124 via the acoustic communications channel 120 to reside and execute in the second execution environment 124 in addition to the user-defined application 130. In such an example, the user-defined application 130 and the another user-defined application 134 can cooperate and communicate with each other, optionally communicating data therebetween for shared processing. In another example, the user-defined application 130 can process data and store it for subsequent further processing by the another user-defined application 134, either as part of a shared processing configuration, or for one application to process required intermediate processed data that is also further processed by the other application to provide additional processed data.

In a further embodiment (FIG. 5), the first execution environment 122 supports a control application 136. The control application 136 is present in the preceding examples, but has not been illustrated thus far for the sake of simplicity and clarity of description. However, in this example, the control application 136 is used to trigger operation of the user-defined application 130. In this regard, when an operational status of the firmware 128 changes, for example a data generation status, such as when a data packet is generated or a data file is saved in the second data store, the user-defined application 130 receives a notification from the control application 136 and the notification triggers the user-defined application 130 to receive the data packet or access the newly created or updated data file. The control application 136 communicates with the user-defined application 130 through an Application Programming Interface (API). The user-defined application 130 then performs the function intended of it.

The skilled person should appreciate that the above-described implementations are merely examples of the various implementations that are conceivable within the scope of the appended claims. Indeed, although the above examples have been described in the context of the ADCP mentioned above, the skilled person should appreciate that other kinds of underwater measurement apparatus can be employed, for example a motion sensor apparatus, such as one comprising a gyrocompass. Additionally or alternatively, in the above examples, the topside computing apparatus 102 is described in the context of delivering the application package 112 to the underwater measurement apparatus 104. However, it should be appreciated that the topside computing apparatus 102 serves other purposes, for example to receive live data generated by the user-defined application 130 and/or the another user-defined application 134, which can be stored in the part of the second data store that records the application data 116. The topside computing apparatus 102 can operate as a proxy and relay the live data to another computing device, for example the remote computing apparatus 106 or a cloud storage resource. A remote computing device can be used to access the topside computing apparatus 102 and download logged data generated by the user-defined application 130 and/or the another user-defined application 134, either stored locally by the first data store of the topside computing apparatus 102 or recovered from the second data store following the remote computing device logging into the topside computing apparatus 102. In another example, the remote computing device can log into the topside computing apparatus 102 and command the underwater measurement apparatus 104, for example to modify predetermined functionality of the user-defined application 130.

In the above examples, the underwater measurement apparatus 104 comprises the pressure vessel. However, in other examples, more than one pressure vessels can be employed, for example a first pressure vessel to contain the communications module and a second pressure vessel to contain the processing resource.

Reference is made, above, to an underwater environment in respect of which measurements are made. However, the skilled person should appreciate that the measurements made by the sensor module, or the one or more additional sensor modules, described herein need not be limited to sensor modules suitable only for making measurements in respect of water. Indeed, the sensor module can be a sensor module configured to make measurements in relation to a medium different to water, for example a material, which can be solid, such as an underwater conduit, such as a pipe, a flexible riser or an umbilical. In this regard, the material can be immersed in the underwater environment and the sensor module would measure an effect of the underwater environment on the material immersed therein or another effect on the material, for example from within the conduit.

Alternative embodiments of the invention can be implemented as a computer program product for use with a computer system, the computer program product being, for example, a series of computer instructions stored on a tangible data recording medium, such as embodied in a computer data signal, the signal being transmitted over a tangible medium or a wireless medium, for example, acoustic, microwave or infrared. The series of computer instructions can constitute all or part of the functionality described above, and can also be stored in any memory device, volatile or non-volatile, such as semiconductor, magnetic, optical or other memory device.

1. A subsea measurement apparatus configured to be immersed, when in use, in water, the apparatus comprising:
a sensor;
a communications module;
a processing resource operably coupled to the sensor and the communications module, the sensor being configured to measure a property of a medium; wherein
the processing resource is configured to provide a first execution environment and a second execution environment independent from the first execution environment;
the first execution environment is configured to execute device firmware that cooperates with the sensor to generate, when in use, measurement data; and
the second execution environment is configured to receive and execute a user-defined application.

2. An apparatus according to claim 1, wherein the user-defined application of the second execution environment is configured to acquire the measurement data having a first information value and to process the measurement data to produce processed output data having a second information value.

3. The apparatus according to claim 1, wherein the user-defined application is a command interpreter configured to receive a first command in accordance with a first command protocol and to translate the first command to a second command in accordance with a second command protocol.

4. The apparatus according to claim 1, wherein the user-defined application is configured to generate a command to control operation of the first execution environment and to communicate the command to the first execution environment in order to modify operational behaviour of the first execution environment.

5. The apparatus according to claim 1, wherein the user-defined application is configured to perform, when in use, a predetermined functionality, the user-defined application being further configured to receive a command associated with the predetermined functionality and the user-defined application is configured to modify the predetermined functionality in response to and in accordance with the received command.

6. The apparatus to claim 1, further comprising:
an acoustic communications transceiver operably coupled to the communications module.

7. The apparatus according to claim 1, wherein the second execution environment is configured to permit replacement of the user-defined application with another user-defined application.

8. The apparatus according to claim 1, wherein the second execution environment is configured to execute the user-defined application in accordance with a predetermined execution frequency.

9. The apparatus according to claim 1, further comprising:
a command interface for receiving an operational command; wherein
the second execution environment is configured to provide access to the command interface.

10. The apparatus according to claim 1, wherein the second execution environment is configured to receive the user-defined application via a communications link and to execute the user-defined application in the second execution environment.

11. A subsea measurement system comprising:
the subsea measurement apparatus according to claim 1; and
a topside module configured to communicate with the subsea measurement apparatus.

12. The system according to claim 15, further comprising:
a computing device independent of the topside module and configured to communicate with the topside module; wherein
the topside module is configured to receive an application package from the computing device.

13. The system according to claim 16, wherein the application package comprises a runtime library and processing code configured to use the runtime library.

14. The system according to claim 16, wherein the computing device comprises, when in use, a software development kit configured to support creation of an application for execution in the second execution environment of the subsea measurement apparatus.

15. A method of compressing measurement data, the method comprising:
providing a processing resource to support a first execution environment and a second execution environment;
executing firmware in the first execution environment;
obtaining a sensor measurement in respect of a medium;
pre-processing the sensor measurement using the firmware to produce measurement data having first information value;
executing a user-defined application in the second execution environment to obtain the measurement data and processing the measurement data in accordance with a predetermined processing algorithm, thereby producing processed measurement data having second information value.

16. A method of providing inter-compatibility with an underwater measurement apparatus, the method comprising:
providing a processing resource in the underwater measurement apparatus to support a first execution environment and a second execution environment;
executing firmware in the first execution environment;
obtaining a sensor measurement in respect of a medium;
pre-processing the sensor measurement using the firmware to produce measurement data having first information value;
executing a user-defined application in the second execution environment to provide a command interpreter configured to receive a first command in accordance with a first command protocol and to translate the first command to a second command in accordance with a second command protocol, the firmware being configured to operate in accordance with the second command protocol.

17. The apparatus according to claim 1, wherein
the first execution environment is configured to support a control application; and
the control application is configured to control execution of the user-defined application.

18. The apparatus according to claim 11, wherein
the control of the user-defined application by the control application is in response to an operational status of the first execution environment.

19. The apparatus according to claim 12, wherein
the operational status of the first execution environment is a data generation status.

20. The apparatus according to claim 13, wherein
the data generation status is an availability of a data file or a data packet.
